(19) United States
(12) Patent Application Publication
(10) Pub. No.: US 2012/0313051 A1
(43) Pub. Date: Dec. 13, 2012

(54) BINDER COMPOSITION FOR MANUFACTURING ELECTRODE OF ENERGY STORAGE DEVICE AND METHOD FOR MANUFACTURING ELECTRODE OF ENERGY STORAGE DEVICE

(75) Inventors: Sergey Remizov, Gyeonggi-do (KR); Craig Miesse, Gyeonggi-do (KR); Hong Seok Min, Gyeonggi-do (KR); Bae Kyun Kim, Gyeonggi-do (KR); Hyun Chul Jung, Gyeonggi-do (KR)

(73) Assignee: SAMSUNG ELECTRO-MECHANICS CO., LTD., Suwon (KR)

(21) Appl. No.: 13/486,663

(22) Filed: Jun. 1, 2012

(30) Foreign Application Priority Data
Jun. 7, 2011 (KR) 10-2011-0054558

(51) Int. Cl. C08B 37/00; C08L 5/00; H01B 1/12

(52) U.S. Cl. 252/500; 536/123.1; 106/501.1

(57) ABSTRACT

Disclosed herein are a binder composition for manufacturing an electrode of an energy storage device and a method for manufacturing an electrode of an energy storage device. The binder composition includes galactomannan as a major component and may exhibit sufficient binding force with a considerably small amount, as compared to binders in the related art. When the binder composition disclosed herein is used to manufacture an energy storage device having the same weight as that manufactured using the binder in the related art, the energy storage device may contain a greater amount of active material, compared to the binder in the related art. Consequently, beneficial effects such as improvement in an energy density as well as eco-friendly characteristics may be rendered.

### CROSS REFERENCE(S) TO RELATED APPLICATIONS

This application claims the benefit under 35 U.S.C. Section 119 of Korean Patent Application Serial No. 10-2011-0054558, entitled “Binder Composition For Manufacturing Electrode Of Energy Storage Device And Method For Manufacturing Electrode Of Energy Storage Device” filed on Jun. 7, 2011, which is hereby incorporated by reference in its entirety into this application.

### BACKGROUND OF THE INVENTION

1. Technical Field

The present invention relates to a binder composition for manufacturing an electrode of an energy storage device and a method for manufacturing an electrode of an energy storage device and, more particularly, a binder composition including galactomannan and/or polysaccharides as well as a method for manufacturing an electrode, using the binder composition.

2. Description of the Related Art

Stable energy supply is important for various electronic devices such as information and communication instruments. A battery generally functions to supply energy. In recent years, as mobile instruments become more important, there is a certain tendency to use a secondary battery capable of supplying energy to a mobile instrument while being repeatedly charged/discharged for several thousands to several tens of thousand of times.

A lithium ion secondary battery is a representative example of the secondary battery described above. The lithium ion secondary battery has a relatively small size and light weight while exhibiting a high energy density sufficient to stably supply power over a long term, however, entails limitations such as low power density, which in turn decreases a peak output power, a long period of time for charging, a short battery lifespan of approximately several thousands charge/discharge cycles, or the like.

In order to overcome such limitations of the lithium ion secondary battery described above, a device called an ‘ultra-capacitor’ or a ‘super-capacitor’ hogging the spotlight in related fields has been recently brought much attention as a next-generation energy storage device, because of high charge-discharge rate, high stability and eco-friendly characteristics thereof. Energy density of such an ultra-capacitor or a super-capacitor is relatively small, compared to lithium ion secondary batteries in related art. However, the ultra-capacitor or the super-capacitor has various advantages such as power density from several tens to several hundreds times that of a lithium ion secondary battery in the related art, a long lifespan of at least several hundreds of thousands charge/discharge cycles, and a very high charge/discharge rate enabling completion of charging within several seconds.

In general, an electrode of an energy storage device such as a secondary battery or super-capacitor is fabricated by applying a slurry including an active material such as activated carbon or graphite, as well as a conductive agent, to a metal plate made of, for example, copper or aluminum as a current collector.

In this regard, a binder is used to bind the active material to the current collector and the binder may greatly influence various characteristics, for example; a capacity of an energy storage device, a hardness and viscosity of a slurry composition, easiness in manufacturing an electrode, stabilization of electro-chemical functions thereof, or the like.

More particularly, the binder may have various functions, for example; provision of binding force between active material particles and/or an active material and a current collector, fulfillment of mechanical properties such as flexibility, elastic property, adhesiveness, or the like, and may enable effective coating of a current collector with an electrode active material.

At present, the binder commonly used in the art may include, for example, carboxymethyl cellulose (CMC).

FIG. 1 illustrates a process of mixing an active material and a conductive agent with a binder in a solvent under agitation. As shown in FIG. 1(a), a free binder may be incorporated in the active material and conductive agent particles and the incorporated binder may be organically bound to and closely combined with the free binder.

Meanwhile, FIGS. 1(b) to (d) show respective cases where an amount of the binder is too small (b) or too great (d), or is suitable (c). As shown in these figures, when the amount of the binder is too small (b), the binding force to the active material is considerably decreased, particles may be easily separated from the electrode during the manufacture of the electrode or after binding, and then, precipitated. On the other hand, if the amount of the binder is too great (d), a weight of the binder in the electrode is increased, which in turn causes reduction in an energy density of an energy storage device.

FIG. 2 shows graphs of a viscosity to a shear-thinning extent (i.e., shear rate) from a rheological point of view.

As shown in FIG. 2(a), as a shear rate becomes lower, molecular entanglement is increased whereas orientation of the molecule is decreased, and a viscosity is increased. On the contrary, when a shear rate becomes higher, molecular entanglement is deceased whereas orientation of the molecule is increased, thus reducing the viscosity.

FIG. 2(b) illustrates an exemplified case where the foregoing principles are applied to a combination of the binder, active material, and conductive agent. It can be seen from the figure that, even though the same amount of binder is used, the viscosity may be reduced as a shear rate becomes higher and, in addition, a binding force between particles is also decreased.

FIG. 3 illustrates a molecular structure of sodium carboxymethyl cellulose (Na-CMC) which is widely used in the related art. As shown in the figure, it can be identified that Na-CMC has a relatively high shear rate.

Since CMC based binders commonly used in the related art including Na-CMC shown in FIG. 3 have a high shear rate, in turn exhibiting a relatively low viscosity, a great amount of binder is needed to render a desired binding force.

However, as an amount of the binder is increased, electrical conductivity of an electrode is sharply degraded.

Further, with regard to the manufacture of an energy storage device having a predetermined weight, if a content of the binder is increased, a content of an active material should be relatively reduced, thus decreasing an energy density.

In addition, if an amount of the binder is increased, it may clog pores of a porous active material such as activated carbon, which in turn reduces activity thereof and ultimately deteriorates output power characteristics. When the binder occupies a surface of an electrode in a secondary battery, this may interfere with an ion exchange mechanism, thus degrading output power.

Alternatively, for a polyvinylidene fluoride (PVDF) widely used in the related art, other than CMC based binders described above, PVDF is a non-aqueous material and requires a volatile organic compound, e.g., N-methyl-pyrrolidone as a solvent. Therefore, a problem of causing environmental contamination during production thereof may be encountered.

Accordingly, studies on development of a binder that can render sufficient binding force while using the least amount of binder, without degradation of a mechanical strength of an electrode as well as dispersible properties of an electrode material, have been continuously conducted.

Furthermore, there is a strong need to develop an eco-friendly binder which can achieve excellent electrical properties, easily be manufactured and do not cause environmental contamination.

### SUMMARY OF THE INVENTION

The present invention has been proposed to overcome the above problems in the related art and an object of the present invention is to provide a binder composition for manufacturing an electrode of an energy storage device, which is prepared using galactomannan, so as to embody sufficient binding force even using a small amount of binder composition, without causing environmental contamination.

Another object of the present invention is to provide a method for manufacturing an electrode of an energy storage device, by using the binder composition described above.

In order to accomplish the above objects, a binder composition for manufacturing an electrode of an energy storage device according to the present invention may include galactomannan.

The binder composition may include polysaccharides.

The binder composition may include a mixture of galactomannan and polysaccharides.

The binder composition may include a mixture of galactomannan and cellulose derivatives.

The binder composition may include a mixture of galactomanann and at least one selected from a group consisting of disaccharides, trisaccharides, tetrasaccharides and olicosaccharides.

In this regard, galactomannan may be selected from a group consisting of guar gum, tara gum, locust bean gum, fenugreek gum and cassia gum.

Additionally, the polysaccharides may be selected from a group consisting of xanthan, gellan, wellan, rhamsan, schizophyllan, scleroglucan, alginate, carageenan and pectin.

Here, a content of the galactomannan in the mixture may range from 1 to 99 wt. %, preferably, 5 to 95 wt. % and, more preferably, 20 to 80 wt. %.

According to one embodiment of the present invention, there is provided a method for manufacturing an electrode of an energy storage device, which includes mixing an active material, conductive agent and binder to prepare a slurry and applying the slurry to a current collector to form an electrode, the method comprising: mixing the binder composition with the active material and conductive agent in a dried state under agitation; and mixing the resultant material with a solvent under agitation, thereby preparing a slurry.

Alternatively, the foregoing method may include: mixing the binder composition with a solvent under agitation; and mixing the resultant material with an active material and conductive agent under agitation, thereby preparing a slurry.

Here, the solvent may include water or ethanol.

The process of preparing a slurry by mixing the resultant material described above with the solvent under agitation and/or the process of mixing the solvent with the binder composition under agitation may be implemented at a temperature of 0 to 100° C. and, preferably, 10 to 90° C.

A content of the binder composition may range from 0.1 to 2 wt. % in relation to a total weight of the slurry.

Other features and aspects will be apparent from the following detailed description, the drawings, and the claims.

### BRIEF DESCRIPTION OF THE DRAWINGS

FIG. 1 is a schematic view illustrating a mixture of a binder, active material and conductive agent in a solvent;

FIG. 2 shows graphs of variation in a viscosity to the shear-thinning of a binder from a rheological point of view;

FIG. 3 illustrates a chemical structure of carboxymethyl cellulose;

FIG. 4 illustrates a chemical structure of galactomannan;

FIG. 5 is a graph showing increase in a viscosity when two materials used in the present invention are mixed together;

FIG. 6 shows graphs of the correlation between a polymer concentration and a viscosity.

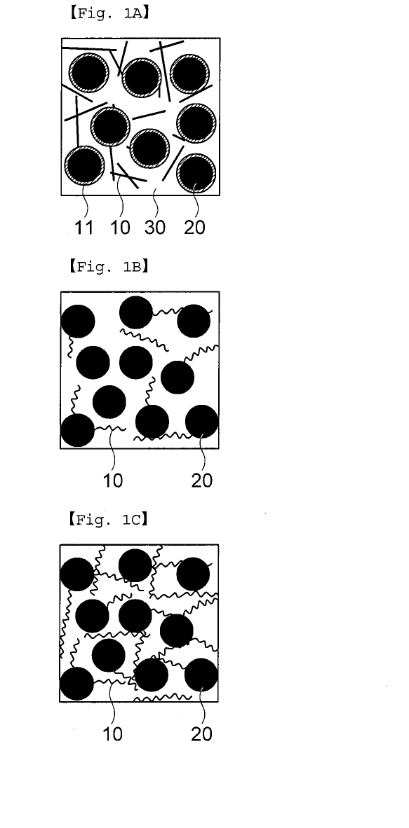

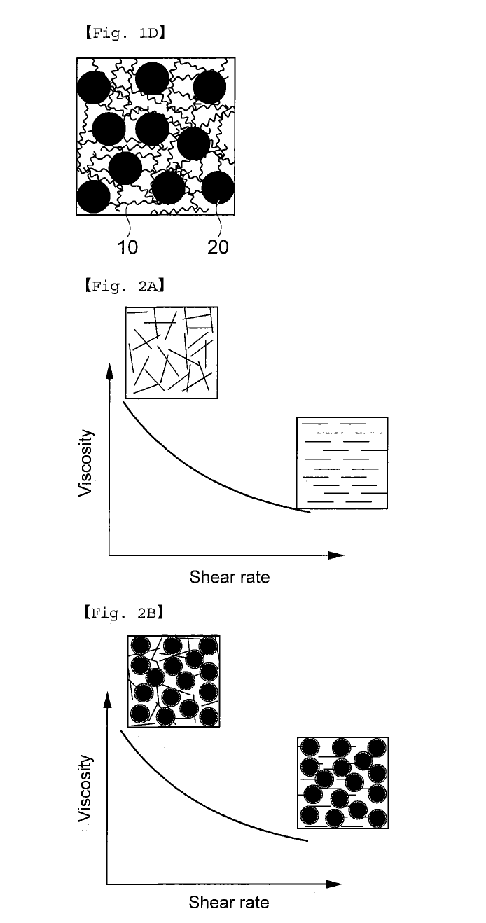

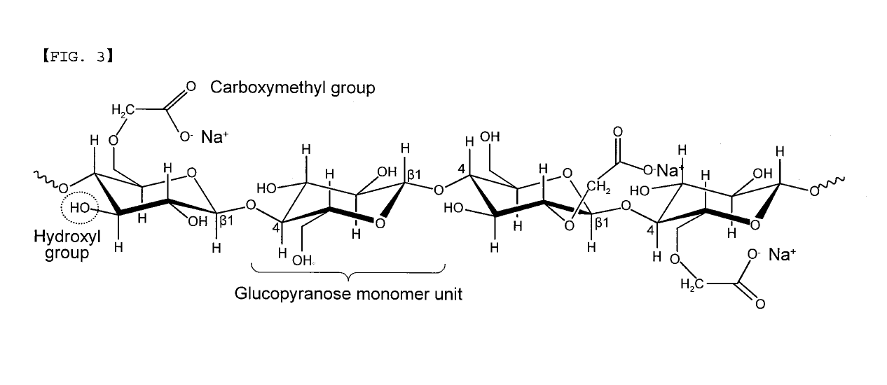

### DESCRIPTION OF THE PREFERRED EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals denote elements substantially having the same configurations or performing similar functions and actions throughout the detailed description.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, a binder composition for manufacturing an electrode of an energy storage device according to the present invention will be described in detail.

The binder composition of the present invention may include galactomannan as a major component.

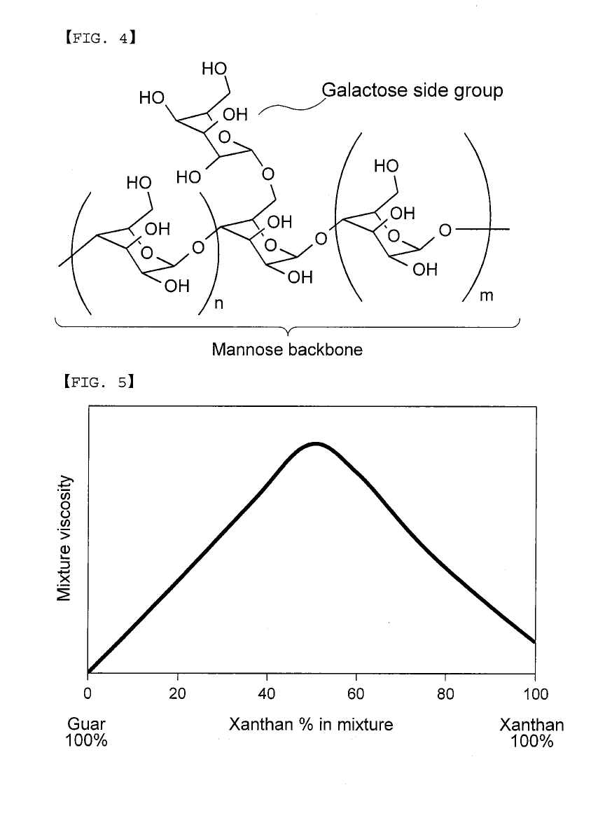

FIG. 4 illustrates a common chemical structure of galactomannan and, as shown in the figure, the galactomannan refers to complex polysaccharides composed of galactose and mannose, and includes guar gum, tar gum, locust bean gum, fenugreek gum, cassia gum, or the like.

Galactose is a hexarose, rarely found in a free state naturally but widely distributed in a polymer form, and has a molecular formula of C₆H₁₂O₆ and a melting point of 168° C. It is usually a white powder having a sweet taste, easily dissolved in water and may have a melting point of 118° C. if water with crystallization is contained. D-galactose naturally exists and the galactose commonly mentioned in the art means D-galactose. D-galactose is broadly distributed in organic life and contained in lactose, agar and/or galactomannan, polysaccharides and glycoproteins/glycolipids of bacterial cell walls, or the like. On the other hand, L-galactose is found in agar, jelly secreted from the surface of sea urchin embryo, or polysaccharides contained in snail extract, or the like. D-galactose may be obtained by hydrolysis of lactose using acid. By concentrating a hydrolysis product and placing the concentrated product in a refrigerator, D-galactose crystals may be generated. As a physiologically important glucose, D-galactose is a constituent of the lactose and a number of compounds containing D-galactose as a constituent, for example, glycolipids distributed in large quantities in the brain or nervous tissues, are broadly distributed. For example, one type of glycolipids present on the surface of a red cell may determine ABO blood types. In B type red cell, galactose may reside at the end of a sugar chain in the glycolipid.

Mannan is a polysaccharide comprising alpha-mannose as a major component and may be composed of mannose only. Otherwise, it may contain a large quantity of galactose or glucose, which is called galactomannan or glucomannan, respectively. Mannan is a major component of hemicelluloses contained in the wood part (or the xylem) of coniferos trees. This material is found in seeds of phytelephas macrocarpa or widely distributed as the storage substance or structural component of a plant. Mannan of phytelephas macrocarpa or mannan contained in storage roots of Orchidaceae plants has a chain-like bonded structure of mannose through β-1,4 bonds and is used as a raw material for preparation of mannose. Yeast and seaweed also contain mannans and a konnyaku mannan is a major component of the konnyaku (so called ‘devil's tongue’) as a food and includes the glucomannan comprising mannose and glucose in a ratio of 2:1. The konnyaku mannan is a polymer compound having a molecular weight of about 1,000,000 and is dissolved in water to become a viscose starch-like paste, which in turn becomes a konnyaku insoluble in alkali. The konnyaku is slightly digested in the digestive fluid of a human but is hydrolyzed in the digestive fluid of the snail or slug.

With regard to the structure of the galactomannan, a main chain is -1,4-bonded mannose while a side chain has -1,6-bonded galactose. A relative ratio of the mannose and galactose ranges from approximately 2:1. Since the galactomannan is dissolved in water to create a sticky hydrophilic colloid, the obtained colloid is widely used as a viscosity enhancer, stabilizer or gelling agent in a variety of foodstuffs.

When dissolved in water, the galactomannan has a viscosity of 10 to 1000 times or more that of pure water and, therefore, may be used as a binder composition to strictly bind an active material and conductive agent to a current collector. The galactomannan may be used in a dissolved state in water without causing environmental contaminants such as volatile compounds, thus having high eco-friendly effects, and may render sufficient binding force even using a small amount thereof. Therefore, compared to a binder in the related art, the binder composition of the present invention may enable remarkable increase in a content of the active material, when the binder composition is used to manufacture an electrode having the same weight as that manufactured using the binder in the related art. Consequently, an energy density and capacity characteristics of an energy storage device may be greatly enhanced.

According to embodiments of the present invention, the binder composition may include polysaccharides.

The polysaccharides may be selected from a group consisting of xanthan, gellan, wellan, rhamsan, schizophyllan, sceleroglucan, alginate, carageenan and pectin.

In the case where the polysaccharides are mixed with galactomannans, smooth and sleek regions of these respective materials actively interact with one another, to thereby considerably increase viscosity of the mixture. By utilizing such a principle and mixing the polysaccharides and galactomannans, a binder composition may be prepared.

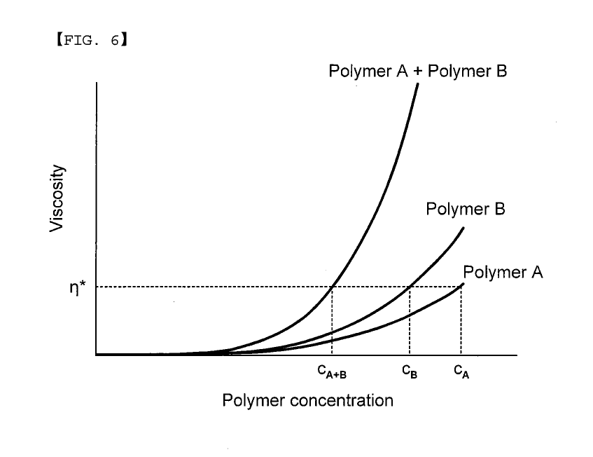

FIG. 5 illustrates measured results of the viscosity after mixing guar gum and xanthan in different mixing ratios.

FIG. 6 illustrates concentrations vs. viscosities of respective materials used in the present invention, and concentration vs. viscosity of a mixture of the foregoing materials. As shown in the figure, it can be seen that the concentration of the mixture of two materials A and B required for obtaining a desired viscosity is lower than the concentration of each of the materials A and B used separately.

Meanwhile, with regard to the mixing of the galactomannan and polysaccharides, a mixing ratio thereof enabling optimization of viscosity characteristics may be varied depending upon types or kinds of materials to be used.

The galactomannan may be mixed with cellulose derivatives to produce a binder.

Alternatively, a binder may be prepared by mixing at least one selected from a group consisting of disaccharides, trisaccharides, tetrasaccharides and oligosaccharides with the galactomannan.

In this regard, a content of the galactomannan in the mixture may range from 1 to 99 wt. %, preferably 5 to 95 wt. % and, more preferably, 20 to 80 wt. %.

The following description will be given to explain a method for manufacturing an electrode of an energy storage device according to the present invention.

In general, an electrode may be formed by combining an active material and conductive agent with a current collector, wherein a binder is used to bind the active material to particles of the conductive agent and to bind the active material and conductive agent to the current collector.

In the case where a CMC-based binder in the related art is used, the active material, conductive agent and binder are typically dissolved in a solvent comprising a volatile organic compound, e.g., N-methyl-pyrrolidone, to prepare a slurry and the slurry is applied to the current collector and dried, thus resulting in an electrode.

However, if using a binder composition of the present invention, the binder composition may be mixed with the active material and conductive agent in a dried state under agitation, followed by mixing the resultant material with a solvent such as water, to thereby prepare a slurry.

Alternatively, after mixing the binder composition with a water-containing solvent under agitation, the active material and conductive agent may be added to the mixture to prepare a slurry.

In this case, the solvent may include ethanol.

Meanwhile, a process of preparing a slurry by mixing the resultant material described above with the solvent under agitation and/or a process of mixing the binder composition with the solvent under agitation may be conducted at 0 to 100° C. and, preferably, 10 to 90° C.

Furthermore, a content of the binder composition may range from 0.1 to 2 wt. % in relation to a total weight of the slurry.

A process of applying the slurry prepared as described above to the current collector to form an electrode is substantially identical to methods in the related art and, therefore, a detailed description thereof will be omitted.

A binder composition prepared according to the present invention as described above may be eco-friendly since the composition is water-soluble and does not require volatile organic compounds such as N-methyl pyrrolidone or PVDF, and may embody sufficient binding force with a considerably decreased amount, as compared to binders in the related art. Therefore, if the binder composition is used to manufacture an energy storage device that has the same weight as the energy storage device manufactured using the binder in the related art, the energy storage device may have the greater amount of active material, thus enabling improvement in the energy density of the energy storage device.

Moreover, the binder composition of the present invention does not exhaust hazardous (toxic) substances during the manufacture of electrodes and may provide sufficient binding force even when using a small amount of binder composition, thereby ensuring safety of the manufacturing process, and may attain other advantages such as increase in process efficiency, no occurrence of environmental contamination for waste disposal.

Herein, the present invention has been described in detail. The foregoing description has disclosed exemplary embodiments of the present invention for illustrative purposes, however, the present invention may be applied in various combinations, alterations and/or environments. In other words, those skilled in the art will appreciate that various modifications, additions and substitutions are possible without departing from the scope and spirit of the invention and their equivalents, and are duly included within the present invention as well as the knowledge and techniques in the related art. The above embodiments were proposed to explain best conditions for embodying the present invention. Therefore, other embodiments well known in the art, to which the present invention as well as other inventions pertain, and, in addition, various alterations required for particular applications and uses of the present invention may be possible. Accordingly, such embodiments in the foregoing description are not intended to limit the scope of the present invention and other embodiments should be construed as being included within the scope of the present invention as defined by the appending claims.

1. A binder composition for manufacturing an electrode of an energy storage device, comprising galactomannan.

2. A binder composition for manufacturing an electrode of an energy storage device, comprising polysaccharides.

3. A binder composition for manufacturing an electrode of an energy storage device, comprising a mixture of galactomannan and polysaccharides.

4. A binder composition for manufacturing an electrode of an energy storage device, comprising a mixture of galactomannan and cellulose derivatives.

5. A binder composition for manufacturing an electrode of an energy storage device, comprising a mixture of galactomannan and at least one selected from a group consisting of disaccharides, trisaccharides, tetrasaccharides and oligosaccharides.

6. The binder composition according to claim 1, wherein the galactomannan is selected from a group consisting of guar gum, tara gum, locust bean gum, fenugreek gum, cassia gum.

7. The binder composition according to claim 2, wherein the polysaccharides are selected from a group consisting of xanthan, gellan, wellan, rhamsan, schizophyllan, scleroglucan, alginate, carageenan and pectin.

8. The binder composition according to claim 3, wherein a content of the galactomannan in the mixture ranges from 1 to 99 wt. %.

9. The binder composition according to claim 3, wherein a content of the galactomannan in the mixture ranges from 5 to 95 wt. %.

10. The binder composition according to claim 3, wherein a content of the galactomannan in the mixture ranges from 20 to 80 wt %.

11. A method for manufacturing an electrode of an energy storage device, which includes mixing an active material, conductive agent and binder to prepare a slurry and applying the slurry to a current collector to form an electrode, the method comprising:
mixing the binder composition according to claim 1 as well as the active material and conductive agent, in a dried state under agitation; and
mixing the material prepared above with a solvent under agitation to prepare a slurry.

12. A method for manufacturing an electrode of an energy storage device, which includes mixing an active material, conductive agent, and binder to prepare a slurry and applying the slurry to a current collector to form an electrode, the method comprising:
mixing the binder composition according to claim 1 as well as a solvent under agitation; and
mixing the material prepared above with the active material and conductive agent under agitation to prepare a slurry.

13. The method according to claim 11, wherein the solvent includes water.

14. The method according to claim 11, wherein the solvent includes ethanol.

15. The method according to claim 11, wherein the preparing of the slurry by mixing the prepared material with the solvent under agitation is conducted at 0 to 100° C.

16. The method according to claim 11, wherein the preparing of the slurry by mixing the prepared material with the solvent under agitation is conducted at 10 to 90° C.

17. The method according to claim 12, wherein the mixing of the binder composition according to claim 1 with the solvent under agitation is conducted at 0 to 100° C.

18. The method according to claim 12, wherein the mixing of the binder composition according to claim 1 with the solvent under agitation is conducted at 10 to 90° C.

19. The method according to claim 11, wherein a content of the binder composition ranges from 0.1 to 2 wt. % in relation to a total weight of the slurry.
